(19) United States
(12) Patent Application Publication
(10) Pub. No.: US 2001/0018646 A1
(43) Pub. Date: Aug. 30, 2001

(54) USB simulation apparatus and storage medium

(76) Inventors: Shigeru Nagashima, Kanagawa (JP); Kousuke Kawate, Kanagawa (JP)

Correspondence Address: Fish & Richardson P.C., 45 Rockefeller Plaza, Suite 2800, New York, NY, 10111, US

(21) Appl. No.: 09/789,164

(22) Filed: Feb. 20, 2001

(30) Foreign Application Priority Data
Feb. 28, 2000 (JP) P. 2000-051667

(51) Int. Cl. G06F 17/50

(52) U.S. Cl. 703/13

(57) ABSTRACT

A USB simulation apparatus 1 in an embodiment of the invention sets an address of a device to communicate, a transfer mode or a band by a setting part 12a within a CPU 11, and manages test items (for example, error packet or abnormal sequence) every transaction by a transaction management part 12b, and determines an answer signal inputted from a communication opposed side by a received data determination part 12c, and branches the subsequent processing according to a determination result to select test items or sending data executed in the next transaction.

### BACKGROUND OF THE INVENTION

1. Field of the Invention

The present invention relates to a USB simulation apparatus for virtually performing and verifying communication functions and the operations of personal computers or peripheral units through a USB (Universal Serial Bus).

2. Description of the Related Art

In recent years, peripheral units (devices) such as keyboard, mouse, speaker, modem or printer capable of making connections to a personal computer (host) through an interface based on USB standards have largely been developed.

Communications between the host and the device through the USB are controlled by USB protocol software of the host. That is, even when data is sent from the device side, the host gives a bus use right to the device and thereafter the device sends data to the host.

Concretely, the host and each the device have controllers based on the USB, respectively. The USB controller of the host side issues a token packet to each the device according to a program of USB protocol software. A token means a code in which the device determines whether data is sent from the host to the device (OUT) or sent from the device to the host (IN), and the device performs processing according to the received token packet. Also, a packet means a unit of information outputted by the host or the device or information including a code for identifying a type of the data or an address.

The host draws up a schedule of communication with the device in a unit referred to as a transaction when communicating with the device. For example, when the host first sends a token packet to the device and an exchange of data is completed, the side which has received data sends a handshake packet to the sending side and a communication unit referred to as the transaction is completed.

Incidentally, data flowing on the USB is divided on a time basis by a frame concept, and an SOF (Start of Frame) packet is always added to the beginning of a frame. The host sends and receives each the packet to the device in previously scheduled order subsequently to the SOF packet.

When such data flowing on the USB bus is inspected by a test pattern or an answer from the device through the USB is directly verified on the USB bus, the inspection or verification is generally performed using a USB simulation model.

As shown in FIG. 8, a conventional dedicated simulator 20 for performing a USB simulation comprises memory 21 in which a pattern (USB simulation model) of sending data outputted to the host or the device is stored, a timing generator 22 for controlling sending timing of the sending data, and a code conversion circuit 23 for modulating the sending data to serial data of the USB or demodulating received data.

That is, in the dedicated simulator 20, a sending pattern stored in the memory 21 is divided in a frame manner by the code conversion circuit 23 and a synchronous pattern is added and the pattern is outputted to the host or the device with the timing specified by the timing generator 22.

Also, as shown in FIG. 9, there is the case of performing the USB simulation using a general-purpose USB controller LSI 31. In FIG. 9, a USB simulation system 30 comprises the USB controller LSI 31, a control microcomputer 32 and USB driver software 33, and the control microcomputer 32 controls the USB controller LSI 31 according to a test program stored in the USB driver software 33.

However, in the conventional dedicated simulator 20 as shown in FIG. 8, when timing of synchronization is shifted or resending processing is required due to error data, a connection with a communication opposed side is broken and a normal simulation operation cannot be performed. Also, when an error packet or an abnormal sequence is generated intentionally, because the connection with the communication opposed side is broken every the generation, there was a problem in that work time becomes redundant.

On the other hand, in the USB simulation system 30 shown in FIG. 9, the contents of the USB driver software 33 need to be tuned according to uses for debug to be verified and efforts are expended. Also, in the USB controller LSI 31, the control microcomputer 32 automatically processes sending and receiving data and when an error occurs, a sending retry signal is required to the data out going side, so that the error packet or the abnormal sequence cannot be generated intentionally.

Incidentally, as a technique of performing a simulation while maintaining a handshake of communication, a method of handling software in a packet unit to execute a simulation program is established as a conventional art, but achievement is difficult in the same art since a packet answer in transactions in the USB is very speedy.

### SUMMARY OF THE INVENTION

An object of the invention is to generate an error packet or an abnormal sequence such as a handshake intentionally while maintaining a handshake between a host and a device connected through a USB by a simulation program.

To achieve the above object, according to a first aspect of the invention, there is provided a USB simulation apparatus for virtually executing signal processing communicated between a main unit and a peripheral unit connected through a USB, said apparatus comprising:

storage means for storing plural test items and instructions on a simulation;

sending data management means (for example, a transaction management part 12b within a CPU 11 of FIG. 4) for managing data sent to one or plural external units connected through the USB on the basis of the contents stored in the storage means;

setting means (for example, a setting part 12a within the CPU 11 of FIG. 4) for setting an address of the external unit on the basis of the contents stored in the storage means;

timing generation means (for example, a USB state monitor part 13c within a USB controller 13 of FIG. 4) for generating timing to output data on the basis of the contents stored in the storage means;

data sending means (for example, a sending control part 13d within the USB controller 13 of FIG. 4) for outputting data directed by the sending data management means to the address set by the setting means with the timing generated by the timing generation means;

receiving means (for example, a status monitor part 13f within the USB controller 13 of FIG. 4) for receiving a signal inputted from the external unit through the USB; and determination means (for example, a received data determination part 12c within the CPU 11 of FIG. 4) for determining data to be next sent on the basis of the signal received by the receiving means and outputting the data to the sending data management means, and functions as a virtual main unit or a virtual peripheral unit to the external unit to be connected.

According to the first aspect of the invention, in a USB simulation apparatus for virtually executing signal processing communicated between a main unit and a peripheral unit connected through a USB, storage means stores plural test items and instructions on a simulation, and sending data management means manages data sent to one or plural external units connected through the USB on the basis of the contents stored in the storage means, and setting means sets an address of the external unit on the basis of the contents stored in the storage means, and timing generation means generates timing to output data on the basis of the contents stored in the storage means, and data sending means outputs data directed by the sending data management means to the address set by the setting means with the timing generated by the timing generation means, and receiving means receives a signal inputted from the external unit through the USB, and determination means determines data to be next sent on the basis of the signal received by the receiving means and outputs the data to the sending data management means.

Therefore, the address of the external unit to be connected can be changed in accordance with the contents stored in the storage means, or the timing to output data can be changed, or data to be next outputted can be selected according to the signal inputted from the external unit.

According to a second aspect of the invention, there is provided the USB simulation apparatus as defined in the first aspect of the invention, wherein the sending data management means manages sending data in a transaction unit.

Therefore, information is managed in a batch unit, so that processing in response to the signal inputted from the external unit can be performed though the communication conducted within a bus of the USB is high speed.

According to a third aspect of the invention, there is provided the USB simulation apparatus as defined in the second aspect of the invention, wherein the sending data management means generates error data or an abnormal sequence intentionally.

Therefore, an answer of the external unit to the error data or the abnormal sequence can be checked.

According to a fourth aspect of the invention, there is provided the USB simulation apparatus as defined in the third aspect of the invention, wherein the determination means determines data to be next sent on the basis of a handshake signal inputted from the external unit received by the receiving means and does not disconnect communication until all the test items to the external unit are completed.

Therefore, even in case of generating the error data or the abnormal sequence, a connection with the external unit is not broken and operations such as logical verification in a USB simulation or signal retrieval within the bus can be performed efficiently.

According to a fifth aspect of the invention, there is provided the USB simulation apparatus as defined in the first aspect of the invention, wherein the setting means sets an address of the external unit for sending data and also sets transfer characteristics of sending data in any mode.

Therefore, while sending according to a transfer mode in the address set to the connected external unit can be performed, packet sending is performed in the abnormal sequence in the mode and an abnormal answer of the external unit can be checked.

### BRIEF DESCRIPTION OF THE DRAWINGS

FIG. 1 is a block diagram showing a connection form of a USB simulation apparatus 1;

FIG. 2 is a block diagram showing a connection between the USB simulation apparatus 1 and a device 3;

FIG. 3 is a block diagram showing a connection between the USB simulation apparatus 1 and a host 2;

FIG. 4 is a block diagram showing an internal configuration of the USB simulation apparatus 1;

FIG. 5 is a protocol flow of an OUT transaction;

FIG. 6 is a protocol flow of an IN transaction;

FIG. 7 is a protocol flow of the case of sending and receiving a descriptor;

FIG. 8 is a block diagram showing a configuration of a conventional dedicated simulator 20; and

FIG. 9 is a block diagram showing a conventional USB simulation system 30.

### DETAILED DESCRIPTION OF THE PREFERRED EMBODIMENTS

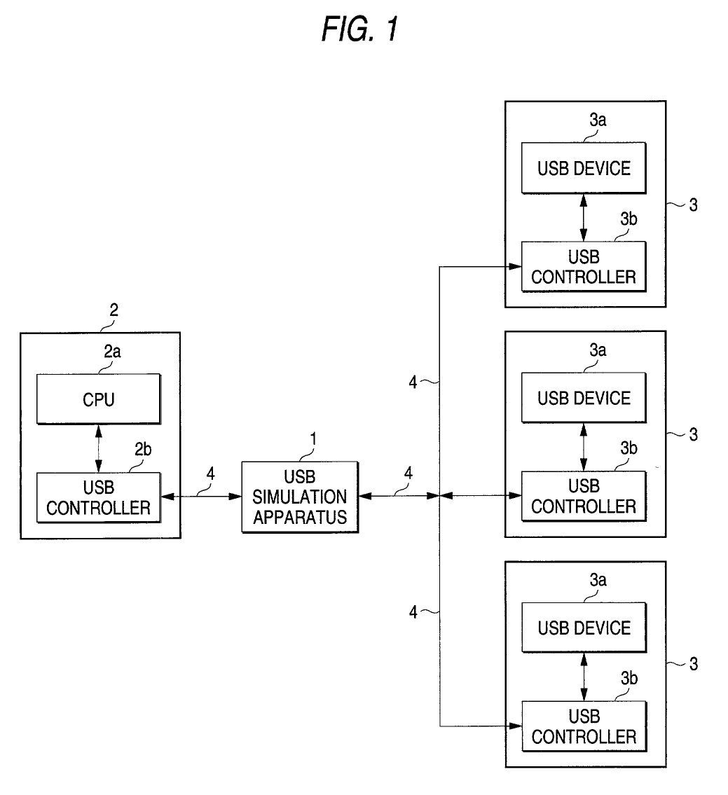

A USB simulation apparatus according to embodiments of the invention will be described in detail with reference to FIGS. 1 to 7 below.

FIG. 1 is a block diagram showing a USB connection form in which a host 2 and plural peripheral units (herein after called “device 3”) are connected to a USB simulation apparatus 1. In FIG. 1, the USB simulation apparatus 1 is connected to USB controllers 2b and 3b of each the unit.

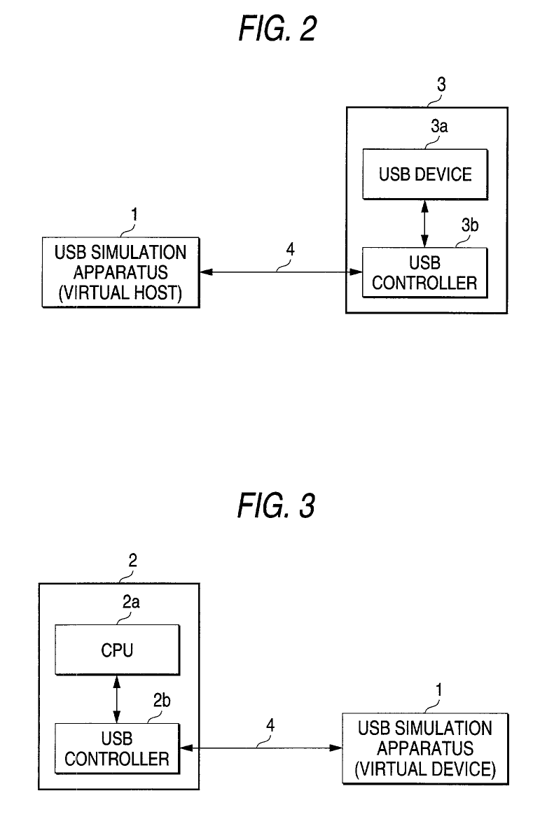

In the embodiment, the USB simulation apparatus 1 acts as a virtual host and communicates with the device 3 (see FIG. 2), or acts as a virtual device and communicates with the host 2 (see FIG. 3).

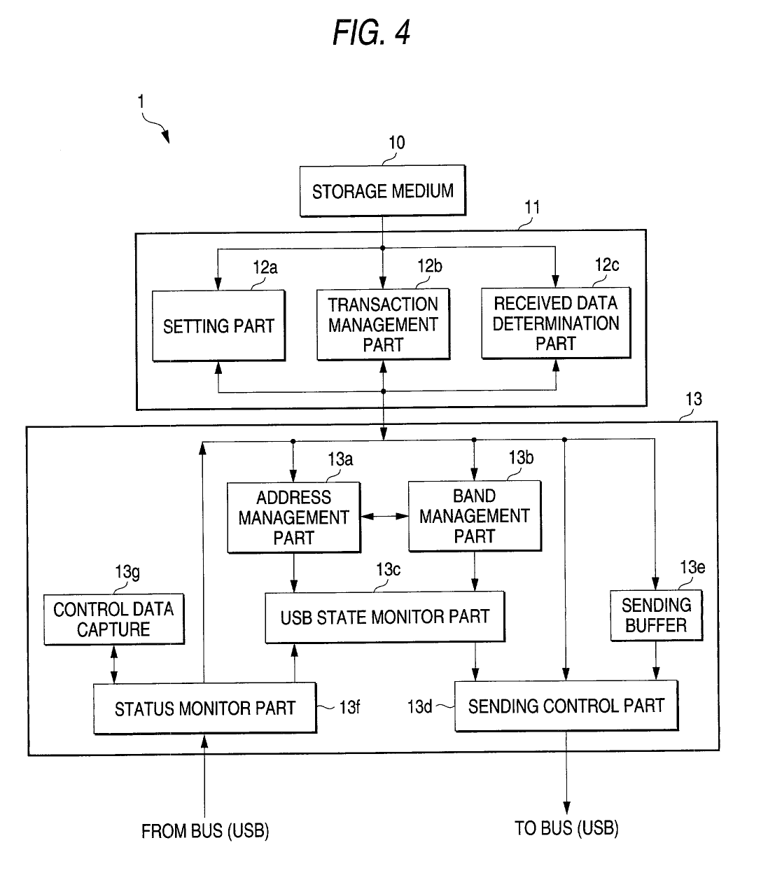

FIG. 4 is a block diagram showing an internal configuration of the USB simulation apparatus 1 in the embodiment. In FIG. 4, the USB simulation apparatus 1 includes a storage medium 10, a CPU 11 and a USB controller 13.

The storage medium 10 has a configuration readable by the CPU 11 such as a magnetic or optical storage medium or semiconductor memory, and includes a medium removable to the USB simulation apparatus 1 or a fixed medium such as a hard disk. A control program for controlling the USB controller 13 or a USB simulation program is stored in the storage medium 10.

The CPU 11 controls the USB controller 13 according to programs stored in the storage medium 10.

Incidentally, the CPU 11 executes the USB simulation program stored in the storage medium 10 by a setting part 12a, a transaction management part 12b and a received data determination part 12c.

The setting part 12a defines a transfer mode, a band and an address setting of a device targeted for a simulation, and outputs a directive signal to an address management part 13a and a band management part 13b within the USB controller 13.

In a USB, communication is conducted by controlling a bus private band to one communication pipe. For example, there are transfer modes such as an interrupt transfer for processing a signal inputted from devices such as a keyboard or a mouse by interrupting in the communication with other devices, a bulk transfer for transferring bulk data, an isochronous transfer for transferring data such as audio or video in which a break causes trouble, or a control transfer in which the host acquires component information of the device.

That is, the setting part 12a determines whether any of the devices communicate in any of the transfer modes. Also, output timing of an SOF packet added to the beginning of a frame is shifted or a directive signal generated in an abnormal sequence is outputted to the address management part 13a and the band management part 13b within the USB controller 13.

The transaction management part 12b generates an expansion directive signal for calling the contents of sending data from the storage medium 10 and expanding the contents to a sending buffer 13e and a sending control signal for controlling an occurrence of an error packet or generation of an abnormal sequence of a handshake answer, and outputs the signals to a sending control part 13d within the USB controller 13.

A transaction means a schedule unit preset to establish communications between the host and the device, and is, for example, a combination of transfer data for beginning by a communication start action from the host to the device and ending by a handshake. That is, the transaction management part 12b determines each of packets (for example, token packet, data packet or handshake packet) within the transaction on the basis of determination results by the received data determination part 12c and programs stored in the storage medium 10, and creates their combinations.

The received data determination part 12c determines whether an answer of a communication opposed side has been normal or abnormal by data inputted from a status monitor part 13f within the USB controller 13, and branches processing to decide data outputted in the next transaction, and outputs a processed result to the transaction management part 12b.

For example, the received data determination part 12c determines an answer of the outputted error packet or abnormal sequence on the basis of the handshake packet inputted from the communication opposed side, and subsequently decides output data not to break the handshake by a conditional branch.

Also, when the control transfer is executed between the host and the device, the host outputs a transfer request (setup packet) of a descriptor to the device in order to know a state of the device. The descriptor is a code for meaning a connection state or a processing state of the device. Thus, when the USB simulation apparatus 1 is a virtual host and performs the control transfer with the device, the received data determination part 12c performs processing according to the descriptor inputted from the device.

The USB controller 13 includes the address management part 13a, the band management part 13b, a USB state monitor part 13c, the sending control part 13d, the sending buffer 13e, the status monitor part 13f and a control data capture 13g, and operates according to directions inputted from the CPU 11.

The address management part 13a manages an address of the device according to directions inputted from the setting part 12a within the CPU 11, and output the address to the USB state monitor part 13c. That is, addresses of one or more devices connected are managed when the USB simulation apparatus 1 is a virtual host, and addresses given from the host are managed when the USB simulation apparatus 1 is a virtual device.

The band management part 13b controls a sending mode and the sending timing of a signal outputted according to directions inputted from the setting part 12a within the CPU 11.

The USB state monitor part 13c monitors a USB bus state on the basis of data inputted from the address management part 13a, the band management part 13b and the status monitor part 13f, and outputs sendable timing, a mode or an address to the sending control part 13d.

The sending control part 13d generates each of packets according to directions inputted from the transaction management part 12b within the CPU 11, and outputs the packets to a USB bus according to timing or a transfer mode inputted from the USB controller 13. Incidentally, when data is outputted, data within the sending buffer 13e expanded according to a sending command inputted from the transaction management part 12b is outputted as a data packet.

The status monitor part 13f decodes a handshake packet or a data packet (for example, descriptor) inputted from a connection opposed side through the USB bus, and outputs the packet to the CPU 11 or the USB state monitor part 13c.

Also, the control data capture 13g stores a decoded result of the status monitor part 13f, and the decoded result stored is read from the status monitor part 13f according to a directive signal inputted from the CPU 11 and is outputted to the received data determination part 12c. By storing a status of the communication opposed side in the control data capture 13g thus, a program in which setup information in the control transfer is reflected exactly is executed.

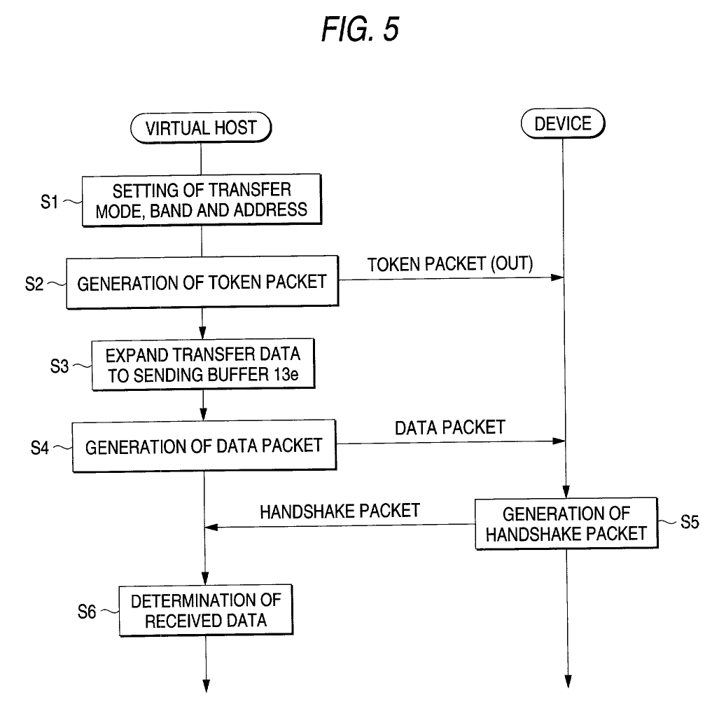

Next, operation in the embodiment of the invention will be described using FIGS. 5 to 7.

FIG. 5 is a protocol flow illustrating an OUT transaction of the case that the USB simulation apparatus 1 is a virtual host and transfers data to a device 3 (see FIG. 2).

In FIG. 5, the CPU 11 of the USB simulation apparatus 1 (virtual host) sets a transfer mode, a band or an address of the device 3 to communicate (step S1), and outputs them to the address management part 13a and the band management part 13b of the USB controller 13.

Then, the CPU 11 outputs token packet generation directions to the sending control part 13d. The sending control part 13d outputs a token packet to the transfer mode, the band and the address (device 3) specified according to timing inputted from the USB state monitor part 13c when generating the token packet according to directions of the CPU 11 (step S2).

When step S2 is completed, the CPU 11 expands data outputted by the virtual host 1 in the transaction to the sending buffer 13e within the USB controller 13 (step S3), and outputs generation directions of a data packet to the sending control part 13d. When the sending control part 13d reads sending data from the sending buffer 13e according to directions of the CPU 11, the sending control part 13d generates a data packet and outputs the data packet to the device 3 according to timing inputted from the USB state monitor part 13c (step S4).

On the other hand, when the data packet is inputted from the virtual host 1, the device 3 determines whether data has been received normally or not and generates a handshake packet and outputs the packet to the virtual host 1 (step S5).

The CPU 11 grasps a communication state of the device 3 from the handshake packet inputted from the device 3 (step S6) and selects a token or data outputted in the next transaction and decides a combination of each the packet within the transaction.

The flow of the OUT transaction of the case that the USB simulation apparatus 1 is the virtual host and outputs data to the device 3 has been described above. Conversely, in the case that the device 3 sends data to the virtual host 1, when the virtual host 1 outputs a token packet to the device 3, the device 3 outputs a data packet to the virtual host 1. Then, the CPU 11 within the virtual host 1 selects a handshake outputted according to the received data packet, and outputs a handshake packet to the device 3 when generating the handshake packet.

The handshake may be selected by a control protocol based on USB standards or may be selected intentionally by a determination command previously stored in the storage medium 10. Also, an error can be generated by shifting timing for outputting the handshake packet.

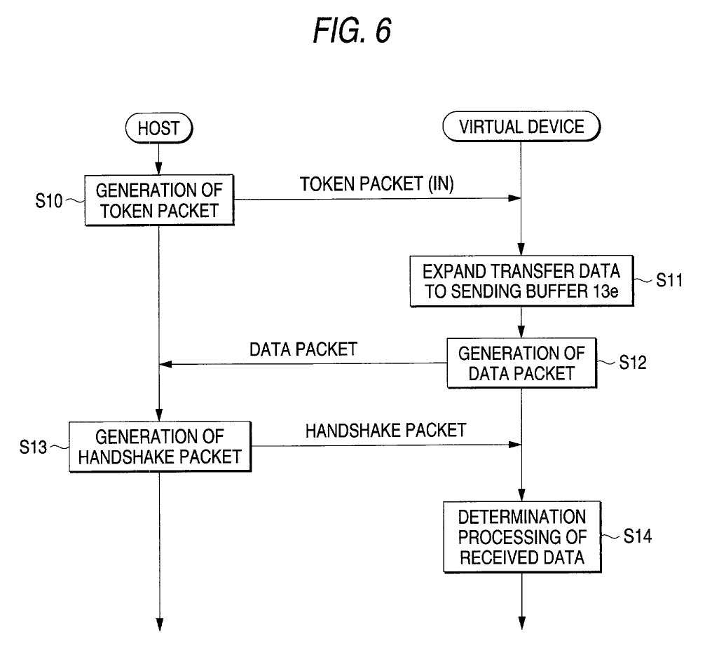

Next, an IN transaction of the case that the USB simulation apparatus 1 is a virtual device and outputs data to a host 2 (see FIG. 3) will be described on the basis of a protocol flow shown in FIG. 6.

In FIG. 6, when the host 2 generates a token packet and outputs the packet to the virtual device 1 (step S10), the CPU 11 of the virtual device 1 expands transfer data to the sending buffer 13e within the USB controller 13 (step S11), and outputs generation directions of a data packet to the sending control part 13d.

The sending control part 13d generates a data packet and outputs the data packet to the host 2 according to timing inputted from the USB state monitor part 13c (step S12).

When the data packet is inputted from the virtual device 1, the host 2 generates a handshake packet and outputs the packet to the virtual device 1 (step S13).

The CPU 11 grasps a communication state of the host 2 from the handshake packet inputted from the host 2 (step S14) and decides data outputted by the virtual device 1 in the next transaction.

The IN transaction of the case that the virtual device 1 transfers data to the host 2 has been described above. Conversely, in the case of an OUT transaction in which the host 2 transfers data to the virtual device 1, the CPU 11 generates a handshake packet according to the received token packet or data packet, and outputs the handshake packet to the host 2.

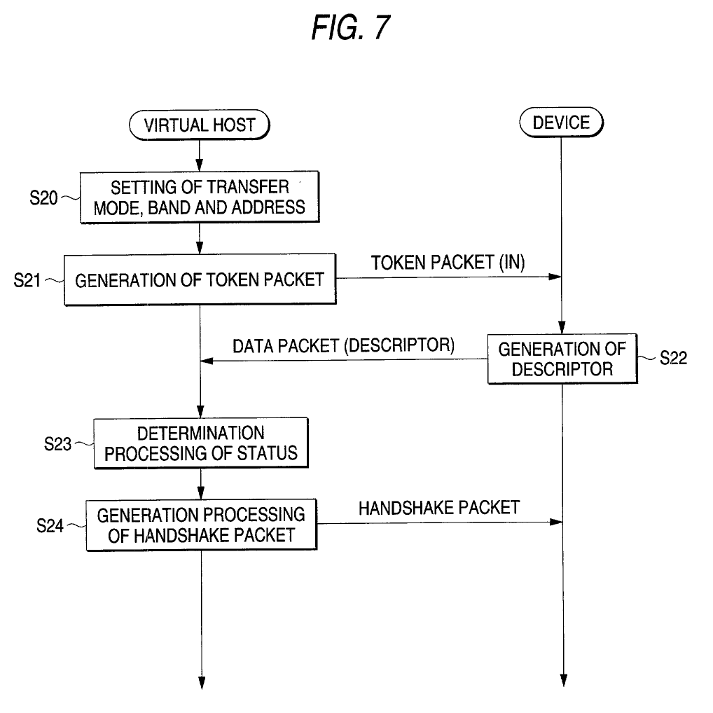

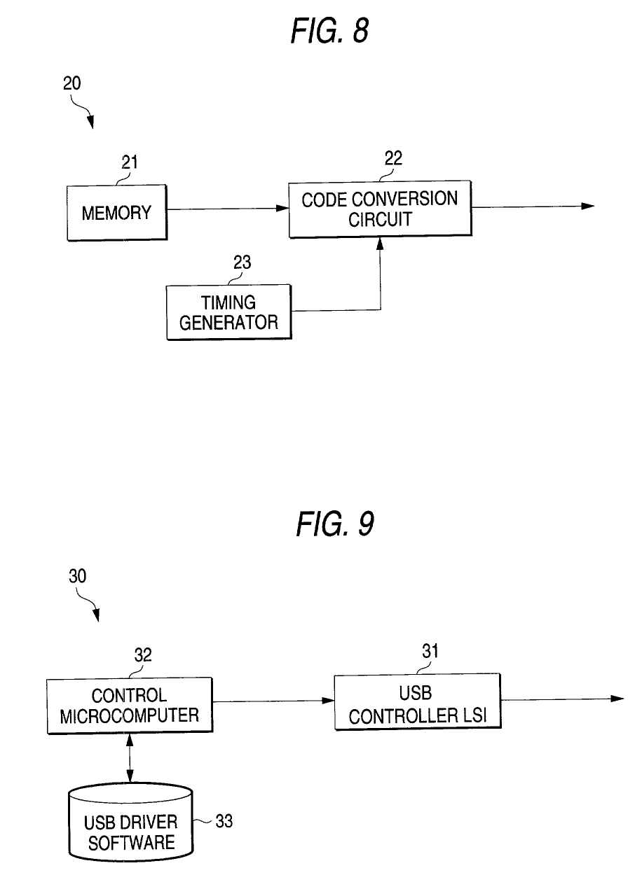

Subsequently, an IN transaction of the case that a device 3 outputs a descriptor according to a request from a virtual host 1 when the USB simulation apparatus 1 is a virtual host and conducts communication with a device 3 by a control transfer (see FIG. 2) will be described using a protocol flow shown in FIG. 7.

In FIG. 7, the CPU 11 of the virtual host 1 sets a transfer mode, a band or an address of the device 3 to communicate (step S20) and outputs a directive signal to the address management part 13a and the band management part 13b of the USB controller 13.

Further, the CPU 11 outputs token packet generation directions to the sending control part 13d. The sending control part 13d outputs a token packet to the transfer mode, the band and the address (the device) specified according to timing inputted from the USB state monitor part 13c when generating the token packet according to directions of the CPU 11 (step S21).

On the other hand, when the token packet is inputted from the virtual host 1, the device 3 generates a data packet (descriptor) and outputs the packet to the virtual host 1 (step S22).

The CPU 11 grasps a communication state of the device 3 from the descriptor inputted from the device 3 (step S23) and selects a token or data outputted in the next transaction and decides a combination of each the packet within the transaction.

Then, the CPU 11 generates a handshake packet to the received data packet and outputs the handshake packet to the device 3 (step S24).

The IN transaction in which the device 3 outputs the descriptor to the virtual host 1 has been described above, but conversely in the embodiment shown in FIG. 3, the invention may be applied to an OUT transaction in which a virtual device 1 outputs the descriptor to a host 2. That is, the contents of the descriptor outputted by the virtual device 1 are changed according to a command for setting a status previously stored in the storage medium 10.

As described above, the USB simulation apparatus 1 in the embodiment of the invention sets an address of a device to communicate, a transfer mode or a band by the setting part 12a within the CPU 11, and sets test items (for example, error packet or abnormal sequence) every transaction by the transaction management part 12b, and determines an answer signal inputted from a communication opposed side by the received data determination part 12c, and branches the subsequent processing according to a determination result to select test items or sending data executed in the next transaction.

Therefore, the USB simulation apparatus 1 can change the contents of the next transaction according to the answer signal inputted from the communication opposed side, so that a handshake with the communication opposed side can be maintained. Also, a transfer mode of a signal outputted by the USB simulation apparatus 1 can be changed at any time by the setting part 12a within the CPU 11, so that an abnormal signal can be issued in real time to check the answer.

Further, a processing unit of a simulation executed by the CPU 11 is set at a transaction rather than a packet, so that it is possible to cope with a high-speed communication in the USB.

Incidentally, the invention is not limited to the contents shown in the embodiment, and changes can properly be made without departing from the substance of the invention. For example, it may be changed so that the invention can be performed using the CPU 2a and the USB controller 2b of the host 2. Also, the protocol flows in the embodiment of the invention are shown in FIGS. 5 to 7, but these flows are changed according to test items or an answer signal of equipment to communicate.

According to a USB simulation apparatus as defined in the first aspect of the invention or a storage medium as defined in the sixth aspect of the invention, an address of an external unit to be connected can be changed in accordance with the contents stored in storage means, or timing to output data can be changed, or data to be next outputted can be selected according to a signal inputted from the external unit.

According to a USB simulation apparatus as defined in the second aspect of the invention, sending data management means manages data in a transaction unit, so that processing in response to a signal inputted from the external unit can be performed though communication conducted within a bus of the USB is high speed.

According to a USB simulation apparatus as defined in the third aspect of the invention, sending data management means generates error data or an abnormal sequence, so that an answer signal of the external unit in these abnormal situations can be checked.

According to a USB simulation apparatus as defined in the fourth aspect of the invention, determination means selects data to be next sent on the basis of a handshake signal inputted from the external unit, so that a connection with the external unit can be maintained even after error data or an abnormal sequence has been generated.

According to a USB simulation apparatus as defined in the fifth aspect of the invention, setting means can change transfer characteristics of sending data, so that data can be sent in a mode different from a transfer mode of the connected external unit. Therefore, an answer of the external unit to an abnormal signal can be checked.

What is claimed is:

1. A USB simulation apparatus for virtually executing signal processing communicated between a main unit and a peripheral unit connected through a USB, said apparatus comprising:
a storage unit adapted to store plural test items and instructions on a simulation;
a sending data management unit adapted to manage data sent to one or plural external units connected through the USB on the basis of the contents stored in said storage unit;
a setting unit adapted to set an address of the external unit on the basis of the contents stored in said storage unit;
a timing generation unit adapted to generate timing to output data on the basis of the contents stored in said storage unit;
a data sending unit adapted to output data directed by said sending data management unit to the address set by said setting unit with the timing generated by said timing generation unit;
a receiving unit adapted to receive a signal inputted from the external unit through the USB; and
a determination unit adapted to determine data to be next sent on the basis of the signal received by said receiving unit and outputting the data to said sending data management unit; characterized by functioning as a virtual main unit or a virtual peripheral unit to the external unit to be connected.

2. A USB simulation apparatus as claimed in claim 1, wherein said sending data management unit manages sending data in a transaction unit.

3. A USB simulation apparatus as claimed in claim 2, wherein the sending data management means generates error data or an abnormal sequence intentionally.

4. A USB simulation apparatus as claimed in claim 3, wherein said determination unit determines data to be next sent on the basis of a handshake signal inputted from the external unit received by said receiving unit and does not disconnect communication until all the test items to the external unit are completed.

5. A USB simulation apparatus as claimed in claim 1, wherein said setting unit sets an address of the external unit for sending data and also sets transfer characteristics of sending data in any mode.

6. A storage medium for storing programs capable of being executed by a computer for virtually executing signal processing communicated between a main unit and a peripheral unit connected through a USB and functioning as a virtual main unit or a virtual peripheral unit to an external unit to be connected, characterized by storing the programs including:
program code for managing data sent to one or plural external units connected through the USB on the basis of plural test items and instructions on a simulation;
program code for setting an address of the external unit on the basis of the plural test items and instructions on the simulation;
program code for generating timing to output data on the basis of the plural test items and instructions on the simulation;
program code for outputting managing data to the set address with the timing;
program code for receiving a signal inputted from the external unit through the USB; and
program code for determining data to be next sent on the basis of the received signal.
